(19) United States
(12) Patent Application Publication
(10) Pub. No.: US 2008/0209170 A1
(43) Pub. Date: Aug. 28, 2008

(54) Method and Device for Performing Switchover Operations and for Signal Comparison in a Computer System Having at Least Two Processing Units

(75) Inventors: Bernd Mueller, Gerlingen (DE); Eberhard Boehl, Reutlingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/666,377

(22) PCT Filed: Oct. 25, 2005
(86) PCT No.: PCT/EP05/55517

§ 371 Date: Mar. 18, 2008

(30) Foreign Application Priority Data
Oct. 25, 2004 (DE) 102004051937.4
Oct. 25, 2004 (DE) 102004051950.1
Oct. 25, 2004 (DE) 102004051952.8
Oct. 25, 2004 (DE) 102004051964.1
Oct. 25, 2004 (DE) 102004051992.7
Aug. 8, 2005 (DE) 102005037242.2

(51) Int. Cl. G06F 9/30

(52) U.S. Cl. 712/43; 712/E09.035

(57) ABSTRACT

A method for switchover and for signal comparison is used in a computer system having at least two processing units, a switchover device being provided, and a switch taking place between at least two operating modes, and a comparison device being provided; and a first operating mode corresponds to a compare mode, and a second operating mode corresponds to a performance mode, wherein at least two analog signals of the processing units are compared in that at least one analog signal is converted into at least one digital value.

### FIELD OF THE INVENTION

The present invention relates to methods and devices for performing switchover operations and for signal comparison in a computer system having at least two processing units

### BACKGROUND INFORMATION

A method for detecting errors in a compare mode is described in PCT International Published Patent Application No. WO 01/46806. In this case, the data are processed and compared in parallel in a processing unit having two ALU processing units. In the event of an error (soft error, transient error), both ALUs work independently of one another until the faulty data are removed and renewed (partially repeated) redundant processing can be undertaken. This requires that both ALUs be able to operate synchronously in relation to each other and that the results be comparable in a process that maintains clock accuracy.

Methods are conventional regarding the manner in which a switch between a compare mode for error detection, in which tasks are processed redundantly, and a performance mode for achieving higher performance can be implemented. This requires that the processing units be mutually synchronized for the compare mode. This requires that both processing units be able to be stopped and that they operate synchronously in a process that maintains clock accuracy, so that the result data are able to be compared with one another as they are written into the memory. This calls for interventions in the hardware, and individual design approaches are proposed.

On the other hand, European Published Patent Application No. 0 969 373 ensures a comparison of the results of redundantly operating processing units or processing units even if they are operating asynchronously in relation to one another, that is, in a process that does not maintain clock accuracy, or at an unknown clock pulse offset.

From the aircraft industry, voting systems are conventional, which are able to use inputs of standard computers and, by employing a majority decision, process these reliably, and on this basis trigger safety-relevant actions. One system that combines inter-processing unit and inter-control unit communication is the FME system, which, because of a high level of redundancy, remains operational even in the case of individual or even a plurality of errors, and which was developed by DASA for aerospace applications (Urban, et al.: A survivable avionics system for space applications, Int. Symposium on Fault-tolerant Computing, FTCS-28 (1998), pp. 372-381). This system can even tolerate Byzantine errors (that is, especially virulent errors where not all components receive the same information, but instead a schemer even “deliberately” distributes various erroneous information to different components). Because of its high cost, such a system is commercially feasible for especially critical systems, which are manufactured in very small numbers. A cost-effective approach that can be manufactured in large numbers and has switchover options in addition, is not known.

### SUMMARY

Example embodiments of the present invention provide a switchover and compare unit that will make it possible to switch the operating mode of two or more processing units, and which in the process is able to do so without intervening in the structure of these processing units and also does not require any additional signals for this purpose. In this context, it is intended that various digital or analog signals from different processing units be able to be compared to one another in a compare mode. Under certain circumstances, the intention is that this comparison even be possible if the processing units are operated using different clock signals, and do not operate in synchronism in relation to one another. Furthermore, example embodiments of the present invention provide methods and devices that allow the comparison of analog signals to be implemented with the aid of digital comparison devices.

A method for performing switchover operations and for signal comparison is used in a computer system having at least two processing units, and where switchover devices are provided and switchover operations are carried out between at least two operating modes, and comparison devices are provided, and a first operating mode corresponds to a compare mode, and a second operating mode corresponds to a performance mode, wherein at least two analog signals of the processing units are compared by converting at least one analog signal into at least one digital value.

At least two of the analog signals may be asynchronous.

The digital signal may be buffer-stored for a specifiable time, so that a direct comparison may take place.

The conversion of at least one signal may be implemented in at least one processing unit.

At least one analog signal may be digitally converted, stored for a specifiable time, and reconverted into an analog signal for the comparison.

Both analog signals may be digitally converted in order to then be available in digital form for a comparison at the same time, by buffer-storing at least the converted digital value.

The digital value of each signal may include a plurality of bits, and a correspondingly specifiable number of bits may be compared to each other as a function of a specifiable accuracy.

The analog signals and their digital values may be compared to each other in redundant manner.

The analog signal may be assigned an identifier during conversion into a digital value.

The identifiers of two signals to be compared may be able to be assigned, and only the particular signals and/or their digital values may be compared whose identifiers are assignable.

A device for performing switchover operations and for signal comparison may be employed in a computer system having at least two processing units, and switchover devices are provided and switchover operations take place between at least two operating modes, and comparison devices are provided, and a first operating mode corresponds to a compare mode, and a second operating mode corresponds to a performance mode, wherein at least two analog signals of the processing units are compared, and an analog-digital converter is provided, and at least one of the analog signals is converted into at least one digital value.

At least two of the analog signals may be asynchronous.

The digital signal may be buffer-stored for a specifiable time, so that a direct comparison may be able to be performed.

At least one signal may be converted in at least one processing unit.

Other features and aspects of example embodiments of the present invention are described in more detail below with reference to the appended Figures.

### BRIEF DESCRIPTION OF THE DRAWINGS

FIG. 1 shows the basic function of a switchover and compare unit for two processing units.

FIG. 1a shows a generalized representation of a comparator.

FIG. 1c shows an expanded representation of a comparator.

FIG. 1b shows a generalized representation of a switchover and compare unit.

FIG. 2 shows a more detailed representation of the switchover and compare unit for two processing units.

FIG. 3 shows one possible implementation of a switchover and compare unit for two processing units.

FIG. 4 shows a more detailed representation of a switchover and compare unit for more than two processing units.

FIG. 5 shows one possible implementation of a switchover and compare unit for more than two processing units.

FIG. 6 shows one possible implementation of a control register.

FIG. 7 shows a voting unit for centralized voting.

FIG. 8 shows a voting unit for decentralized voting.

FIG. 9 shows a synchronization element.

FIG. 10 shows a handshake interface.

FIG. 11 shows a difference amplifier.

FIG. 12 shows a comparator for a positive voltage difference.

FIG. 13 shows a comparator for a negative voltage difference.

FIG. 14 shows a circuit for storing an error.

FIG. 15 shows an analog-to-digital converter with output register.

FIG. 16 shows the representation of a digitally converted analog value having an identifier and analog bit.

FIG. 17 shows the representation of a digital value as digital word including a digital bit.

### DETAILED DESCRIPTION

In the following text, an execution unit or processing unit may denote both a processor/core/CPU, as well as an FPU (floating point unit), a DSP (digital signal processor), a co-processor or an ALU (arithmetic logic unit).

A system having two or more processing units is considered. In principle, safety-relevant systems provide the option of using such resources either to enhance the performance by assigning different tasks to the various processing units to the greatest extent possible. Alternatively, some of the resources may also be used redundantly relative to one another, by assigning the same task to them and detecting an error in the case of a disparate result.

Depending on how many processing units there are, a plurality of modes is possible. A two-unit system has the two modes “comparison” and “performance”, as described above. In a three-unit system, besides the pure performance mode in which all three processing units work in parallel, and the pure compare mode in which all three processing units calculate redundantly and a comparison is made, it is also possible to realize a 2-out-of-3 voting mode, in which all three processing units calculate redundantly and a majority selection is made. In addition, a mixed mode may be realized as well in which, for instance, two of the processing units calculate redundantly in relation to one another and the results are compared, while the third processing unit executes a different, parallel task. In a system of four or more processing units, still further combinations are possible.

A goal to be achieved is to allow the available processing units in a system to be used in a variable manner during operation, without necessitating an intervention in the existing structure of these processing units (e.g., for synchronization purposes). Each processing unit may be able to operate at its own clock pulse, that is, be able to execute the same tasks for comparison purposes also asynchronously in relation to one another.

A universal, broadly utilizable IP is created, which allows a switchover of the operating modes (e.g., comparative mode, performance mode or voting mode) at any desired point in time without previous switching off of the processing units, and which manages the comparison or the voting of the data streams that are possibly asynchronous to one another. This IP may be arranged as chip, or it may be integrated on one chip together with one or more processing units. In addition, it is not required that this chip be made up of only one piece of silicon; it is entirely possible that it is made up of separate components.

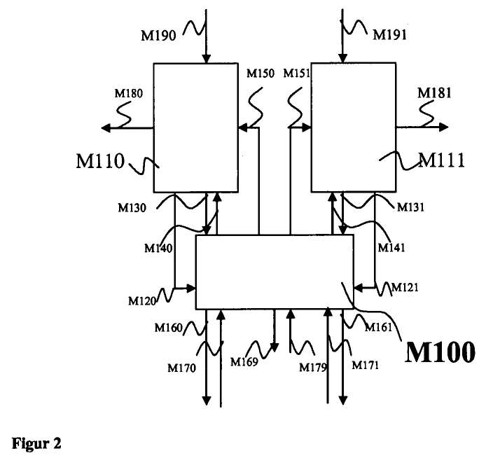

In order to ensure synchronous operation among various processing units, signals are required that prevent execution of the programs of individual processing units from continuously advancing. To that end, a WAIT signal is typically provided. If an execution unit does not have a wait signal, it may also be synchronized via an interrupt. For this purpose, the synchronization signal (for example, M140 in FIG. 2) is not transmitted to a wait input, but applied to an interrupt. This interrupt must have sufficiently high priority over the processing program and also over other interrupts, in order to interrupt the normal mode of operation. The associated interrupt routine executes only a certain number of NOPs (blank instructions with no effect on data), before the system returns to the interrupted program and thereby delays further processing of the processing program. In some instances, during the interrupt routine, the usual storage operations must still be performed at the beginning and at the end, to ensure that the normal program processing is not impaired by the interrupt.

This procedure is continued until synchronous operation has been brought about (for example, other processing units deliver the expected comparative data). However, this method is able to only conditionally ensure a precise clock pulse synchronism, and, in particular, phase equality with other processing units. Thus, when using the interrupt signal for synchronization purposes, it is recommended that the data to be compared be buffer-stored in the SCU before being compared.

Any commercially available standard structures may be used, because no additional signals are required (no intervention in the hardware structure), and any desired output signals of these components are able to be monitored, which, for instance, are used directly to control actuators. This includes the checking of converter structures, such as DACs and PWMs, which, previously under conventional arrangements, are not been able to be directly checked in this manner by a comparison process.

However, if there is no need to check individual tasks or SW tasks, the switch may also be made to a performance mode in which different tasks are distributed among various processing units.

Another feature is that, in a compare or voting mode, there is no need for all of the data to be compared. Only the data to be compared or voted are synchronized with one another in the switchover and compare unit. The process of selecting these data may be variable (programmable) because of the selective response of the switchover and compare unit, and it may be adapted to the particular processing unit architecture, as well as to the application. Thus, diverse PCs or software components may also be used quite easily because only results that lend themselves to a meaningful comparison are also actually compared.

In addition, every access to a (for example, external) memory may be monitored in this manner or also only the control of external I/O modules. Internal signals may be checked via the software-controlled additional output to the switchover module on the external data and/or address bus.

All control signals for the comparative operations are generated in the, e.g., programmable switchover and voting unit, and the comparison takes place there as well. The processing units (for example, processors), whose outputs are to be compared with one another, may use the same program, a duplicated program (which additionally allows the detection of errors when accessing the memory), or also a diversified program for detecting software errors. In the process, there is no need to mutually compare all of the signals supplied by the processing units; instead, an identifier (address or control signal) may also be used to designate or not designate certain signals for the comparison. This identifier is evaluated in the switchover and compare device and the comparison operation is controlled thereby.

Separate timers monitor deviations in the time response beyond a specifiable limit. Some or even all of the modules of the switchover and compare unit may be integrated on one chip, accommodated on one common board or even in a spatially separate manner. In the latter case, the data and the control signals are exchanged with one another via suitable bus systems. Local registers are then written to via the bus system and control the procedures by the data and/or addresses/control signals stored therein.

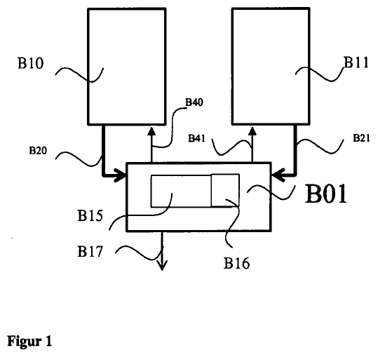

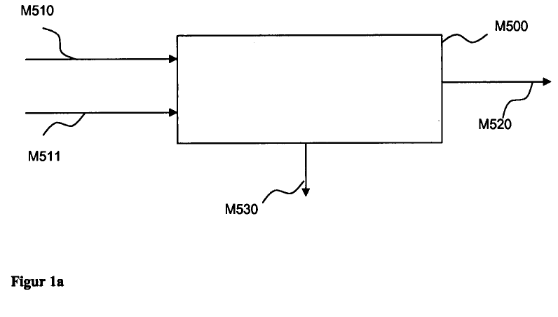

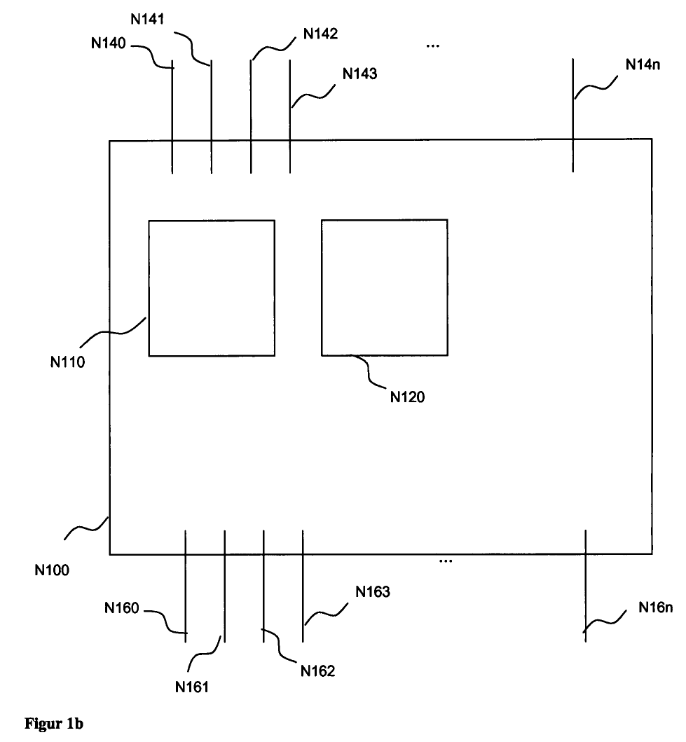

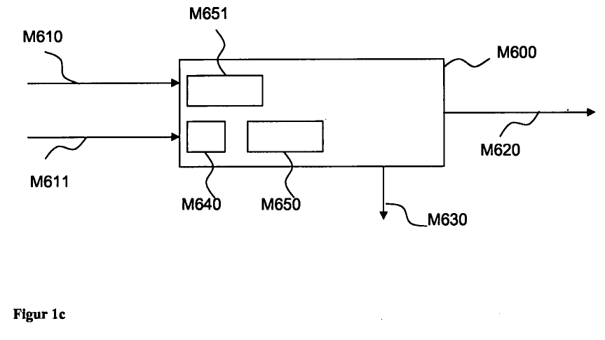

FIG. 1 shows the basic function of switchover unit BO1 according to an example embodiment of the present invention for the application in connection with two processing units B10 and B11. Various output signals, such as data, control and address signals B20 or B21 of processing units B10 and B11, respectively, are connected to switchover unit BO1. Moreover, there is at least one synchronization signal, in the example embodiment of the system, the two output signals B40 and B41, which communicates with one of the comparison units.

The switchover unit includes at least one control register B15, which has at least one memory element for a binary sign (bit) B16, which switches the mode of the compare unit. B16 is able to assume at least the two values 0 and 1, and may be set or reset by signals B20 or B21 of the processing units or by internal processes of the switchover unit.

If B16 is set to the first value, the switchover unit operates in compare mode. In this mode, all data signals incoming from B20 are compared to the data signals from B21, provided that certain specifiable comparison conditions of the control and/or address signals from signals B20 and B21 are met which signal the validity of the data and the comparison specified for these data.

If these comparison conditions are simultaneously met for both signals B20 and B21, then the data from these signals are compared directly and an error signal B17 is set in the case of disparity. If only the compare condition from either signals B20 or B21 is met, then the appropriate synchronization signal B40 or B41 is set. In the corresponding processing unit B10 or B11, this signal causes the processing to stop, and therewith prevents forward switching of the corresponding signals, which up to then could not be compared to one another. Signal B40 or B41 remains set until the corresponding compare condition of the other respective processing unit B21 or B20 is met. In this case, the comparison operation is performed, and the corresponding synchronization signal is reset.

To ensure the comparison in the case that the two processing units supply the data to be compared non-simultaneously, as described, it is either necessary that the data and comparison conditions of the respective processing unit be held to the corresponding values until the corresponding synchronization signal B40 or B41 has been reset, or that the data provided first be stored in the switchover unit until the comparison takes place.

The processing unit that is the first to make data available must wait before continuing to execute its program or its processes until the other processing unit supplies the corresponding comparison data.

An example embodiment of the switchover unit according to FIG. 1 provides that one of signals B40 or B41 may be omitted if it is always ensured that the associated processing unit does not supply comparison data before the other processing unit.

If B16 is set to the second value, synchronization signals B20 and B21 as well as error signal B17 are always inactive and set to the value 0, for instance. Also, no comparison is carried out, and the two processing units operate independently of each other.

In the system according to an example embodiment of the present invention, the comparator is a component. It is shown in its simplest form in Figure la. Comparator component M500 is able to receive two input signals M510 and M511. It then compares them for parity, in the context described here, e.g., in the sense of a bit parity. If it detects disparity, error signal M530 is activated, and signal M520 is deactivated. In the case of parity, the value of input signals M510, M511 is applied to output signal M520, and fault signal M530 does not become active, i.e., it signals the status “good.” Using this basic system as a point of departure, a multiplicity of broadened example embodiments is possible. To begin with, component M500 may be designed as a so-called TSC component (totally self checking). In this case, error signal M530 is routed to the outside via at least two lines (“dual rail”), and internal design and fault detection measures ensure that this signal is present in a correct or identifiably incorrect form in every possible case involving a fault of the comparator component. An example embodiment for using the system according to the present invention provides for such a TSC comparator to be used.

An example embodiments may be distinguished by the degree of synchronism required of the two inputs M510, M511 (or M610, M611). One possible variant is characterized by clocked synchronism, i.e., the process of comparing the data may be carried out using one clock pulse. A slight variation arises when, given a fixed phase displacement between the inputs, a synchronous delay element is used, which delays the corresponding signals by whole numbered or even half clock pulse periods, for example. Such a phase displacement is utilized in avoiding common cause errors, i.e., errors which can simultaneously affect a plurality of processing units. Therefore, in FIG. 1c, component M640, which delays the earlier input by the phase offset, is inserted in addition to the components from illustration M5. This delay element may be accommodated in the comparator, in order that it be used only in the comparison mode. Alternatively or additionally, intermediate buffers may be placed in the input chain, to provide asynchronous operations to be tolerated as well. They may be designed as FIFO memories. If such a buffer is present, then asynchronous operations may also be tolerated up to the maximum depth of the buffer. In such a case, a fault signal must be output also when the buffer overflows.

Moreover, in the comparator, example embodiments may be differentiated by the manner in which signal M520 (or M620) is generated. An example embodiment provides for applying input signals M510, M511 (or M610, M611) to the output and for the connection to be interruptible by switches. An aspect of this variant is that the same switches may be used for switching between the performance mode and possible different compare modes. Alternatively, the signals may also be generated from buffer memories that are internal to the comparator.

An example embodiments may be differentiated by how many inputs are present at the comparator and by how the comparator is to react. In the case of three inputs, a majority voting, a comparison of all three, or a comparison of only two signals may be undertaken. In the case of four or more inputs, an equal number of more variants is possible. For example, these variants are to be coupled to the various operating modes of the overall system.

To explain the general case, FIG. 1b shows a generalized representation of a switchover and compare unit, as it may be used. Of the n execution units to be considered, n signals N140,. . . , N14n are transmitted to switchover and compare component N100. From these input signals, this component is able to generate up to n output signals N160, . . . , N16n. In the simplest case, the “pure performance mode”, all signals N14i are routed onto the corresponding output signals N16i. In the opposite limit case, the “pure compare mode”, all signals N140, . . . , N14n are conducted to exactly only one of output signals N16i.

This figure illustrates how the various possible modes may be produced. To this end, this figure includes the logical component of a switching logic N110. The component, as such, need not exist. It is merely important that its function be present. To begin with, it specifies how many output signals there actually are. Furthermore, switching logic N110 specifies which input signals contribute to what output signals. In this context, one input signal may contribute to precisely one output signal. Formulated mathematically, the switching logic thus defines a function that assigns one element of set {N160, . . . , N16n} to each element of set {N140, . . . , N14n}.

The function of processing logic N120 then specifies for each output N16i in which form the inputs contribute to this output signal. This component, as well, does not necessarily need to exist as a separate component. Decisive, again, is that the described functions be realized in the system. To describe the different variation possibilities by way of example, it may be assumed, without limiting universality, that output N160 is generated by signals N141, . . . , N14m. If m=1, this simply corresponds to switching of the signal; if m=2, signals N141, N142 are compared. This comparison may be implemented synchronously or asynchronously; it may be performed on a bit-by-bit basis, or only for significant bits or also using a tolerance range.

In the case that m>=3, a plurality of options is provided.

One first option provides for comparing all of the signals, and, in response to the presence of at least two different values, for an error to be detected, which may optionally be signaled.

A second option provides for making a k-out-of-m selection (k >m/2). This may be implemented through the use of comparators. An error signal may optionally be generated if one of the signals is determined to be deviant. A possibly differing error signal may be generated if all three signals are different.

A third option provides for supplying these values to an algorithm. This may take the form of generating an average value, a median value, or of using a fault-tolerant algorithm (FTA), for example. Such an FTA is based on deletion of the extreme values of the input values and on a type of averaging of the remaining values. This averaging may be performed for the entire set of the remaining values or, e.g., for a subset that is easily formed in HW. In such a case, it is not always necessary to actually compare the values. In the averaging operation, it is merely necessary to add and divide, for example; FTM, FTA or median generation require partial sorting. If appropriate, here, too, an error signal may optionally be output if the extreme values are sufficiently large.

These different mentioned options of processing a plurality of signals to form one signal are denoted as comparison operations for the sake of brevity.

Thus, the task of the processing logic is to establish the exact form of the comparison operation for each output signal, and thus also for the corresponding input signals. The combination of the information of switching logic N110 (i.e., the function named above) and of the processing logic (i.e., the establishment of the comparison operation per output signal, i.e., per functional value) is the mode information, and this determines the mode. Generally, this information is multi-valued, i.e., not representable by only one logic bit. Not all theoretically possible modes are practical in a given implementation; e.g., the number of permitted modes will be limited. It is important to note that, in the case of only two execution units, where there is only one compare mode, the entire information may be condensed onto only one logic bit.

A switch from a performance mode to a compare mode is generally characterized in that execution units, which are mapped to different outputs in the performance mode, are mapped to the same output in the compare mode. This may be implemented by providing a subsystem of execution units in which, in the performance mode, all input signals N14i to be considered in the subsystem are directly switched to corresponding output signals N16i, while, in the compare mode, they are all mapped to an output. Alternatively, such a switchover operation may also be implemented by altering pairings. This demonstrates that, generally, it is not possible to speak of the performance mode and the compare mode, although, in example embodiments, the number of permitted modes may be limited such that this general case does apply. However, it is always possible to speak of a switch from performance mode to compare mode (and vice versa).

Software-controlled switchover operations between these modes may be dynamically carried out during operation. In such a case, the switchover operation is triggered by the execution of special switchover instructions, special instruction sequences, explicitly identified instructions or in response to the accessing of specific addresses by at least one of the execution units of the multiprocessor system.

FIG. 2 shows a two-processor system or a two μC system described in greater detail, which has a switchover and compare unit M100, in which various of the drawn-in signals may optionally also be omitted. It is made up of two processing units (M110, M111) and a switchover and compare unit M100. Each processing unit emits data signals (M120, M121) and address/control signals (M130, M131) to the switchover unit, and in return each processing unit optionally also receives data (M150, M151) and control signals (M140, M141) from the switchover unit. Unit M100 outputs data (M160, M161) and status information M169, and receives signals such as data (M170, M171) and control signals M179, which are also able to be forwarded to the processing units. Via M170, M171 and M179, it is optionally also possible to set the operating mode of unit M100 independently of the processing units; via outputs M120, M121 (such as data bus) and control and address signals M130, M131 (write, for instance), the processors are also able to set the operating mode in unit M100, such as performance mode (without comparison) or compare mode (with comparison of signals M120, M121 and/or signals M170, M171, which come from peripheral units, for instance). In performance mode, outputs M120, M121 are forwarded to outputs M160, M161, possibly in conjunction with control signals, and, conversely, inputs M170, M171 are forwarded to M150, M151. In compare mode, the outputs are compared and, e.g., forwarded to M160, M161 only in the fault-free case, both outputs being usable optionally, or only one of both. An examination of input data M170, M171, which are forwarded to the processing units, is possible as well. In the case of an erroneous comparison of the signals in compare mode, an error signal is generated and signaled to the outside (component of status information M169), for instance, using double-rail signals: fail-safe. Status M169 may also include the operating mode or information about the time offset of the signals of the execution units. In the case that the comparison data of a processing unit are not made available within a specified (programmable) time interval, the error signal is also activated. If an error has occurred, outputs M160, M161 may be blocked (fail silent response). This may affect digital as well as analog signals. However, these output driver stages are also able to output the undelayed (not buffer stored) output signals M120, M121 of a processing unit, with the option of subsequent error detection. This is tolerated by a safety-relevant system, as long as the error tolerance time is not exceeded, i.e., the time in which an (inert) system does not yet react catastrophically to errors, so that a correction is still possible.

Output signals M180, M181, which are not directed into the SCU, and internal signals of a processing unit may also be compared, at least with respect to their calculated value, by outputting this value to outputs M120, M121 for the purpose of comparison. A similar procedure may also be carried out with input signals M190, M191, which do not arrive via M100.

In order to monitor unit M100, it may be possible for selected or even all signals M160, M161 to read them back via M170, M171 or even M190, M191. This makes it possible to ensure in the compare mode as well, that faulty signals from unit M100 are detected. With the aid of a suitable switch-off path, to which M100, M110, M111 have access (in an OR link), a fail-silence response of the entire system may be brought about.

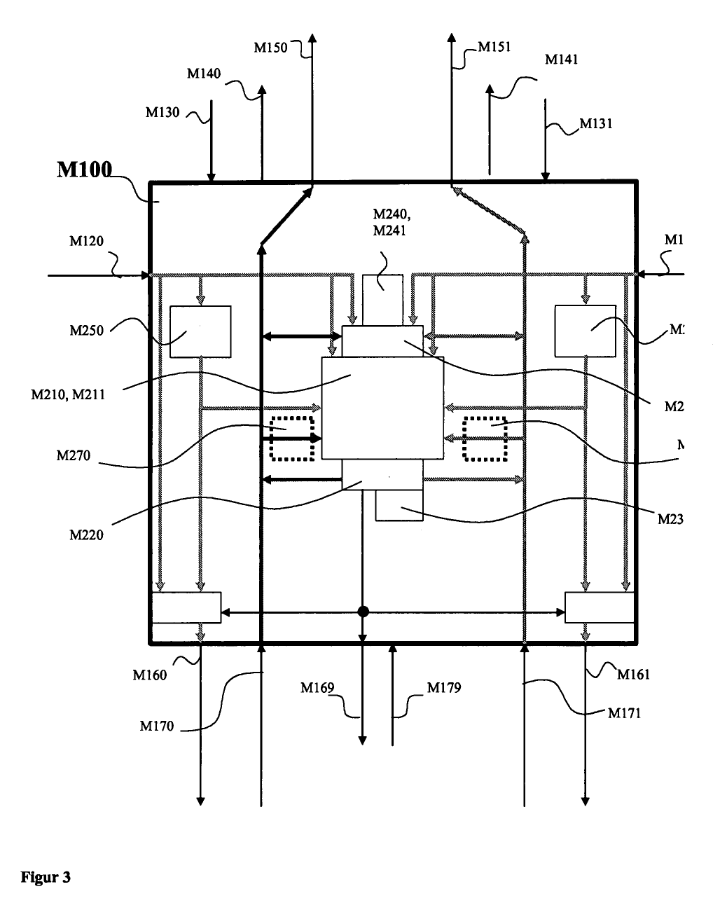

One possible implementation of switchover and compare unit M100 of FIG. 2 is shown in detail in FIG. 3. Unit M100 includes a control register M200 having at least one bit, which represents the mode (performance/compare), and a status register M220 having at least one bit, which represents the error state in the comparative mode. The wait and interrupt signals are controlled by other bits in the control register for both processing units, respectively. In the process, the need may arise to distinguish among different interrupts, such as for synchronization purposes, to prepare for switching the operating modes, and for handling faults.

Optionally, there may be additional control registers, such as M240, which includes the maximum allowable time difference (in number of clock pulses) between the processing units for triggering an internal or external watchdog, as well as M241, which has the time difference value (number of clock periods) above which the fastest processor is to be stopped intermittently or delayed by WAIT or interrupt signals, in order, for example, to prevent data registers from overflowing.

Also stored in status register M220, for example, besides the error bit, is the magnitude of the current clock pulse offset between the processing units. To that end, at least one timer M230 is always started by a processing unit, for example, whenever a data value specially marked (by address and control signals, such as a specific address region) is first made available, and the value of the timer is clocked into the status register whenever the data value in question is made available by the second processing unit. Beyond that, the timer may be set such that even at different program sequences corresponding to the WCET (worst case execution time) it is guaranteed that all processing units have to supply one datum. In the case that the specified value is exceeded by the timer, an error signal is output.

Outputs M120, M121 of the processing units are to be stored in a buffer memory M250, M251 in M100, especially for the compare mode, if digital data are involved and they are not able to be made available with clock accuracy. This memory may be designed as a FIFO. If this memory has a depth of only one (register), then it must be ensured through the use of wait signals, for example, that the outputting of additional values is delayed until the comparison process has taken place, in order to avoid a loss of data.

Furthermore, there is a compare unit M210, which compares the digital data from input memories M250, M251, direct inputs M120, M121 or M170, M171 to each other. This compare unit is also able to compare serial digital data (for example, PWM signals) with one another, when, for example, the serial data are able to be received in memory unit M250, M251 and converted into parallel data, which are then compared in M210. It is possible to synchronize asynchronous digital input signals M170, M171 via additional memory units M270, M271. As is also the case for input signals 120, 121, these may be buffered-stored in a FIFO. The switchover between performance mode and compare mode takes place by setting or resetting the mode bits in the control register, whereby, for instance, corresponding interrupts are caused in the two processing units. The comparison itself is induced by supplied data M120, M121 and the associated address and control signals M130, M131. Certain signals from M120 and M130 or M121 and M131 may act as identification, which indicates whether a comparison of the associated data should take place.

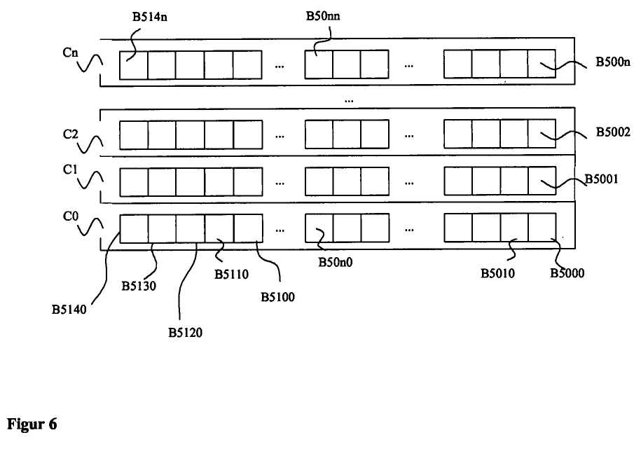

This example embodiment is a continuation of the simple switchover configuration in FIG. 1. In this case, the interrupt routines are used to advantageously make various preparations when the transition is made to a compare mode, in order to create identical initial conditions for both processing units. If the processing unit is finished with this process, it sets the processor-specific ready bit in the control register, and the processing unit remains in the wait state until the other processing unit, by its ready bit, signals its readiness as well (see also the description of the control register in FIG. 6).

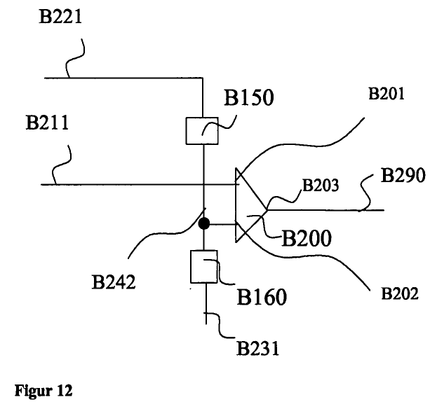

In this compare unit, analog data may be compared with one another in an analog compare unit M211 specially suited for this purpose. However, this presupposes that the analog signals are output synchronously enough relative to one another, or that provision is made for storing in the analog compare unit the data digitized by an ADC implemented there (in this regard, see further explanations regarding FIGS. 12 through 14). The synchronicity is achievable by mutually comparing the digital outputs of the processing units (data, address and control signals) as described above, and letting the processing unit that is too fast, wait. For this purpose, the digital signals, which are processed as source of the analog signals in the processing unit, may also be passed to unit M100 via outputs M120, M121, although these signals are otherwise not needed externally. This redundant comparison in addition to the comparison of the analog signals ensures that an error in the computation is able to be detected earlier, and besides that, this simplifies the synchronization of the processing units. The process of comparing the analog signals results in an additional error detection for the DAC (digital to analog converter) of the processing unit. Such a possibility is not given in other structures of the DCSL architectures. A comparison is also possible for analog input signals from the peripheral units. In particular, if redundant sensor signals of the same system parameter are involved, then no additional synchronization measures are required but, in some instances, only a control signal indicating the validity of the sensor signals. The implementation of a comparison of analog signals will still be shown in detail.

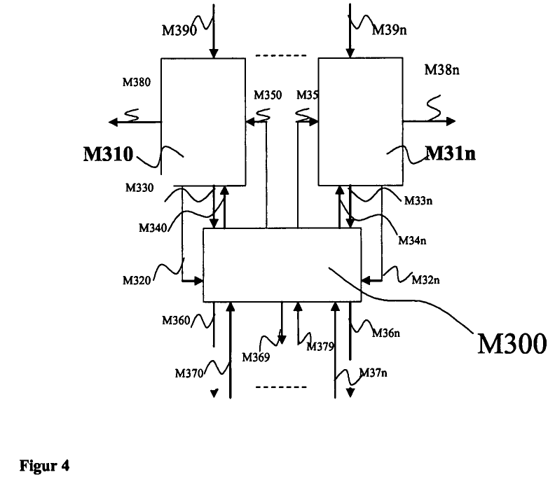

FIG. 4 shows a multiprocessor system having at least n+1 processing units, each of these components in turn also being able to be composed of a plurality of sub-processing units (CPUs, ALUs, DSPs having corresponding additional components). The signals from these processing units communicate with a switchover and compare unit in precisely the same manner described for the two-unit system according to FIG. 2. Therefore, with respect to content, all of the components and signals in this figure have the same significance as the corresponding components and signals in FIG. 2. Switchover and compare unit M300 is able to distinguish in the multiprocessor system among the performance mode (all of the processing units execute different tasks), the various comparison modes (the data of two or also of a plurality of processing units are to be compared and an error is to be signaled in the case of deviations), and the various voting modes (majority decision in the case of a deviation, in accordance with different specifiable algorithms). For each processing unit a separate decision may be made as to which mode it is operating in and together with which other processing units it is possibly operating in these modes. The precise manner in which the switchover operation is carried out is described below following the description of the control registers according to FIG. 6.

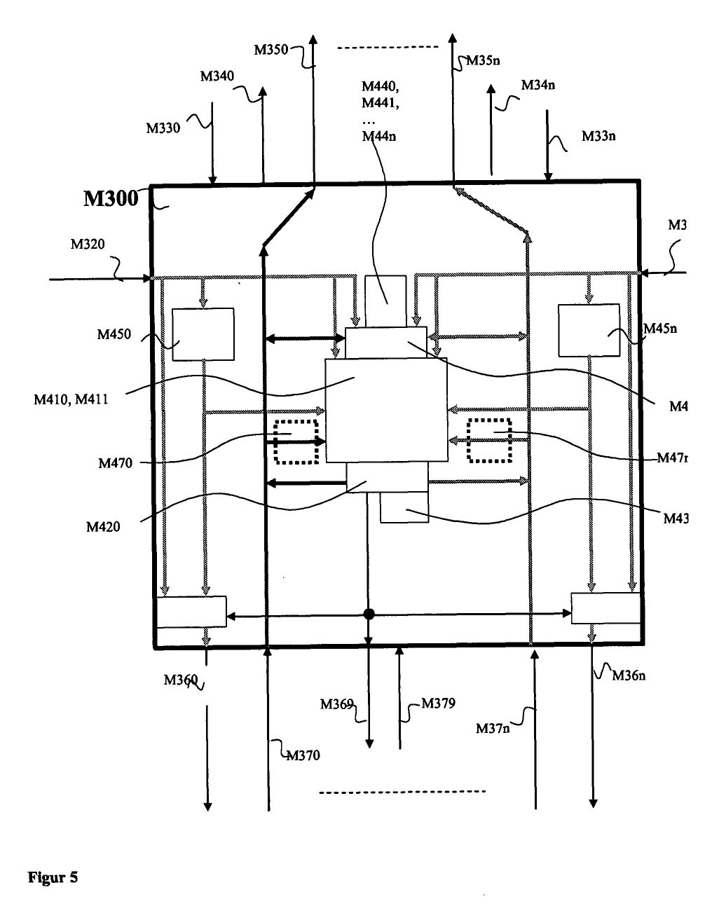

FIG. 5 shows one possible implementation of a switchover unit for a multiprocessor system having n+1 processing units. For each processing unit, at least one control register M44i is provided in the control unit of the switchover and compare module. One exemplary set of control registers is shown and described in detail in FIG. 6. M44i corresponds to control register Ci in each instance.

Different example embodiments in the control register are possible. Suitable bit combinations may be used to describe whether an error detection pattern or an error tolerance pattern should be used. Depending on the degree of complexity of unit M300, the type of error tolerance pattern (2 out of 3, median, 2 out of 4, 3 out of 4, FTA, FTM . . . ) to be used, may be specified in addition. Moreover, a configurable design is possible with regard to which output is to be switched through. Accordingly, one may also devise example embodiments as to which components may influence this configuration for which piece of data.

The output signals from the processing units involved are compared to one another in the switchover unit. Since the signals are not necessarily processed in a process that maintains clock accuracy, the data must be buffer-stored. In the process, in the switchover unit, data may also be compared that are transmitted by the various processing units to the switchover unit at a greater time difference. Using a buffer store (in the form of a FIFO memory, for instance: first in—first out, or in a different buffer form as well), a plurality of data may also initially be received by one processing unit, while other processing units are not making any data available yet. In this context, a measure of the synchronous operation of the two processing units is the occupancy level of the FIFO memory. If a specific, predefinable occupancy level is exceeded, then the processing unit that is the furthest advanced in the processing is intermittently stopped, either by an available WAIT signal or by suitable interrupt routines, in order to wait for the processing units that are not advancing as quickly in the processing. In the process, the monitoring should be extended to encompass all externally available signals of a processing unit; this includes analog signals or PWM signals as well. This requires that structures that permit a comparison of such signals be provided in the switchover unit. Moreover, it is provided that a maximum time deviation be specified among the data to be compared and that it be monitored using at least one timer.

If, generally, more than two processing units are linked to one another by one shared switchover unit, then one control register is required for each of these processing units. One particular arrangement of these control registers is elucidated in FIG. 6.

The (n+1) lower bits B 500x to B50nx of the respective control register Cx are unequivocally assigned to the n+1 processors/processing units. Bit B514x of control register Cx switches between comparison/voting on the one hand and parallel processing on the other hand, and corresponds to the value of B16 in FIG. 1. Bit B513x indicates whether the respective processing unit is ready for comparison (ready), bit B512x controls the synchronization signal (WAIT or INTERRUPT), and bit B511x may be used to prepare respective processing unit x for the comparison by an interrupt. Accordingly, bit B5110x controls an interrupt, which switches the processing unit back into the parallel mode.

If B50ik and B50kk of control register Ck are set to one, (0≦i, k≦n), this means in this example embodiment that the outputs of processing unit i are to be compared to those of processing unit k. If, in addition, B50jk is also equal to 1, then voting is to take place among i, j and k, and the voting result is output at output k of the SCU (0≦i, j, k≦n). To this end, for each group of processing units, a special type of voting or also of only a majority comparison, may be established, as explained previously with respect to illustration M4. In general, all bits B50ik for processing units i to be compared/voted must be set (in control register Ck) if the voting result is to be output at output k of the SCU. A parallel outputting to other outputs is possible.

A one in B50ii of control register i (0≦i, ≦n) indicates that output i of the compare unit is to be active. If all control registers Ci carry a one (i=0, 1, . . . n) only in the corresponding memory areas B50ii, then all processing units are working in performance mode using arbitrarily different programs and their own output signals. If all of the n+1 low-order bits B50ik are equal to one (i =0, 1, . . . n), and, moreover, B514k is set, then the output signals of all processing units are selected by majority decision (voting) and output to output k of the SCU; in the case of n=1, only a comparison is made.

The following describes exemplarily how a sequence might appear when the transition is made to a comparison/voting in a system having a plurality of processing units.

Bit B514i in control register Ci is set in order to activate the comparison or the voting process. This bit may be set by the processing unit itself, as well as by the switchover and compare unit, as a function of specific system states, time conditions or other conditions (such as accesses to certain memory areas, errors or implausibilities). If bits B50ii and B50ki are set with B514i, then bits B511i and B511k are automatically set by the SCU and interrupts are thereby triggered in processing units i and k. These interrupts cause the processing units to jump to a certain program location, to carry out certain initialization steps for the transition to the comparison mode, and then to output an acknowledgment (ready) to the switchover and compare unit. The ready signal causes an automatic resetting of interrupt bit B511i in the corresponding control register Ci of the processing unit and, at the same time, the setting of wait bit B512i. When all of the wait bits of the processing units taking part have been set, they are simultaneously reset by the switchover and compare unit. The processing units then begin with the process of executing the program parts to be monitored. In an example embodiment, writing into a control register Ci having a set bit B514i is prevented by locking (HW or SW). This has the practical effect of ensuring that the configuration of the comparison cannot be changed during execution. A change in control register Ci is possible only after bit B514i has been reset. This resetting effects interrupts in the respective processing units by setting bits B510x in the control registers of all participating processing units for the transition to normal mode (parallel method of operation).

The consistency of all control registers with respect to one another is monitored in accordance with user specifications, and, in the case of an error, an error signal will be generated, which constitutes part of the status information. Thus, for example, a processing unit must not be used simultaneously for a plurality of independent comparison or voting processes because synchronization will not be ensured in such a case. Possible, however, is a comparison of even a plurality of processing units, without outputting of the data signals, but rather only for the purpose of generating an error signal in the case of disparity.

An example embodiment provides that the entry in a plurality of, or all, control registers of the processing units participating in a comparison or a voting operation be made in a substantially identical fashion, i.e., the corresponding bits of these processing units are to be set there in a substantially identical fashion, in some instances with the exception of their own bit i, which controls the output.

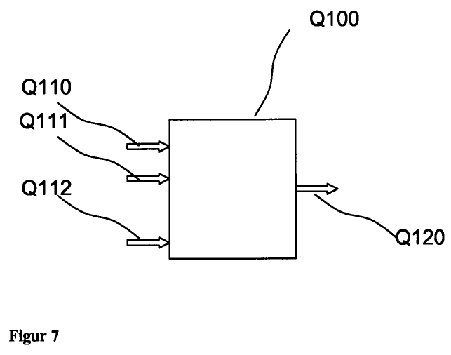

FIG. 7 shows voting unit Q100 for central voting. Voting may be carried out both by using suitable hardware as well as software. The voting algorithm (e.g. bit-precise voting) for this is to be specified. Voting unit Q100 receives several signals Q110, Q111, Q112 and forms an output signal Q120 from these, which is created by voting (e.g., an m-out-of-n selection).

If an error occurs in the comparison, the error bit is set in the respective control register. In a voting process, the piece of data of the respective processing unit is ignored; in a simple comparison, the output is blocked.

All data that are not available in time before expiration of the programmed time are treated as errors. Resetting of the error bits is implemented in a system-dependent manner and, if appropriate, allows a reintegration of the respective processing unit.

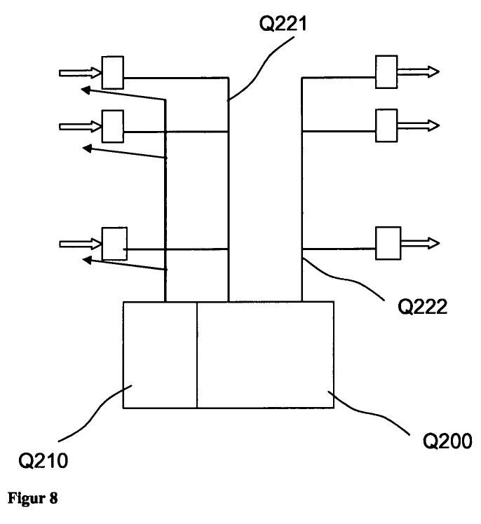

If the processing units and/or the voter are/is not disposed in a spatially concentrated manner, decentralized voting in conjunction with a suitable bus system according to FIG. 8 is possible as well. In FIG. 8, a decentralized voting unit Q200 is controlled by a control unit Q210. It is linked via bus systems Q221, Q222, receives data via these bus systems, and outputs them there again as well.

The resetting of the compare and voting bit in a control register having an active output bit produces an interrupt in the participating processing units, which are then returned to a parallel mode of operation again. Each processing unit may have a different vector address, which is administered separately. The program processing may then also be implemented via the same program memory. However, the accesses are separate and, typically, to different addresses. If the security-relevant part is negligible in comparison to the parallel modes, it should be considered whether a dedicated program memory having a duplicated security part would perhaps require less expenditure.

The data memory, as well, may be shared in the performance mode. The accesses then take place sequentially, using the AHB/ABP bus, for example.

As a special feature, it also should be mentioned that the error bits must be analyzed by the system. To ensure reliable deactivation in the case of an error, the security-relevant signals should be implemented redundantly in a suitable form (for instance, in the one-of-two code).

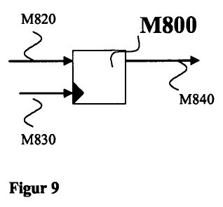

In the existing SCUs in accordance with FIGS. 1, 2, 3, 4 and 5, the initial assumption was that the processing units are working with clock pulses that are the same or that are derived from one another and which are in a constant phase relation with one another. If clock pulses from various oscillators and generators, whose phase relations change, are used for the processing devices as well, then the signals generated in the process must be synchronized when they change clock domains. To this end, a synchronization element M800 is shown in FIG. 9. In order to reliably store and compare the digital data, in particular, synchronization devices M800 will be required, which may be placed at any location in the signal flow. These ensure, for one, that data M820 are stored using clock pulse M830 of the processing unit that supplies these data. The reading process employs the clock pulse that is used for further processing of piece of data M840. Such a synchronization stage M800 may be designed as a FIFO, to provide a plurality of data to be stored (see FIG. 9). Generally, synchronization of the data alone does not suffice; instead, the provisioning signal of the data must also be synchronized with the receiver clock.

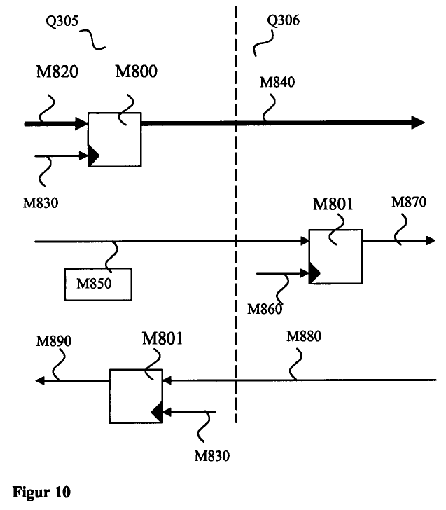

Moreover, a handshake interface is required (FIG. 10), which ensures the transfer via request signals M850 and acknowledge signals M880. Such an interface is required whenever the clock domain changes, in order to ensure reliable transmission of the data from one clock domain to the other. During the write process, data M820 from area Q305 are made available in register cells M800 in synchronized form, using clock pulse M830, and a write request signal M850 indicates the provisioning of the data. Using clock pulse M860, this write request signal is transferred from area Q306 into a memory element M801 and, as synchronized signal M870, it indicates the provisioning of the data. Synchronized piece of data M840 is then clocked in at the next active clock pulse edge of clock pulse M860, and a confirmation signal M880 is sent back in the process. In a further memory element M801, this confirmation signal is synchronized by clock pulse M830 to form signal M890, and the process of provisioning the data is thereby ended. New data may then be written into the register in question. Such interfaces are conventional and, in example embodiments, they are able to work very rapidly by employing an additional encoding, without having to wait for an acknowledge signal.

In an example embodiment, memory elements M800 are designed as FIFO memories (first in, first out).

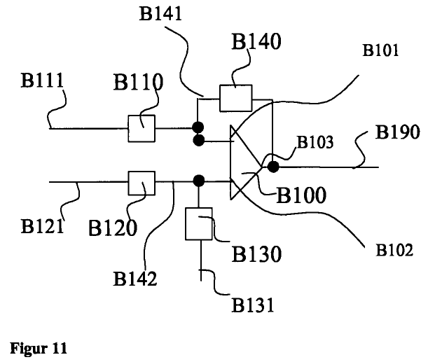

In the case of the circuits used to compare analog signals of FIG. 11 through FIG. 14, the assumption is made that the processing units, which supply the analog signals to be compared, are synchronized with one another such that the comparison is meaningful. The synchronization may be accomplished by the corresponding signals B40 and B41 of FIG. 1.

FIG. 11 shows a differential amplifier. This element may be used to compare two voltages with one another.

In this context, B100 is an operational amplifier to whose negative input B101 a signal B141 is applied, which is connected, via a resistor B110 having the value Rᵢₙ, to input signal B111 at which voltage value V₁ is present. Positive input B102 is connected to signal B142 which, via resistor B120 having the value Rᵢₙ, is connected to input B121 at which voltage value V₂ is present. Output B103 of this operational amplifier is connected to output signal B190, which has voltage value Vₒᵤₜ. Signal B190 is connected, via resistor B140 having value R_{f}, to signal B141, and signal B142 is connected, via resistor B130 having value R_{f}, to signal B131, which has the voltage value of analog reference point V_{agnd}. The output voltage may be calculated according to the following formula using the voltage and resistance values indicated above:

Vₒᵤₜ=R_{f}/Rᵢₙ(V₂-V₁) (1)

If the differential amplifier is operated only at a positive operating voltage, as is typically the case for a CMOS, then a voltage between operating voltage and digital ground is selected as analog ground V_{agnd}, typically the mean potential. If the two analog input voltages V₁ and V₂ are only slightly different, then output voltage Vₒᵤₜ will have only a slight difference V_{diff} from the analog ground (positive or negative).

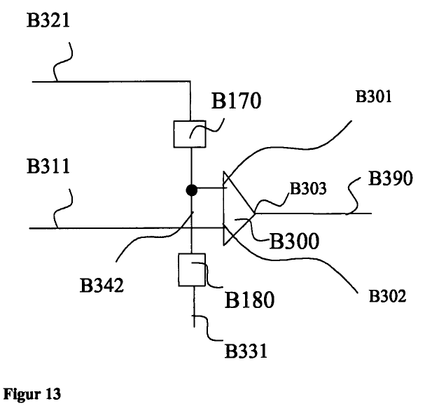

With the aid of two comparators, it is then tested whether the output voltage lies above V_{agnd}+V_{diff} (FIG. 12) or below V_{agnd}−V_{diff} with respect to the analog reference point (FIG. 13). In this context, in FIG. 12, input signal B221 is connected, via resistor B150 having value R2, to signal B242, which is connected to positive input B202 of operational amplifier B200. Furthermore, signal B242 is connected, via resistor B160 having value R₂, to signal B231, which is utilized as digital reference potential V_{dgng}. Negative input B201 of the operational amplifier is connected to input signal B211, which has the voltage value of a reference voltage V_{ref}. Output B203 of operational amplifier B200 is connected to output signal B290, which has voltage value V_{high}.

In FIG. 13, input signal B321 is analogously connected, via resistor B 170 having value R₃, to signal B342, which is connected to negative input B301 of operational amplifier B300. Furthermore, this signal B342 is connected, via resistor B180 having value R4, to signal B331, which also bears digital reference potential V_{dgnd}. Positive input B302 of operational amplifier B300 is connected to input signal B311, which has the voltage value of a reference voltage V_{ref}. Output B303 of operational amplifier B300 is connected to output signal B390, which has voltage value V_{low}.

This is achieved by dimensioning resistors B150, B160, B170 and B180 with their respective values R₁, R₂, R₃ and R₄ in relation to fixed reference voltage V_{ref} present at signals B211 and B311, as follows:

V_{ref}=(V_{agnd}+V_{diff}) *R₂/(R₁+R₂) (2)

V_{ref}=(V_{agnd}−V_{diff}) *R₄/(R₃+R₄) (3)

V_{diff}=((V₂ₘₐₓ−V₁ₘᵢₙ) *R_{f}/Rᵢₙ)−V_{agnd} (4)

In this context, V₂ₘₐₓ denotes the maximum tolerated voltage value of V₂ at signal B121, and V₁ₘᵢₙ denotes the minimum tolerated voltage value of V₁ at signal B111. The reference voltage source may be made available externally, or implemented by an internally realized band gap (temperature-compensated and operating voltage-independent reference voltage). In equation (4), the maximum tolerated difference V_{diff} is determined from the maximum positive deviation V₂ₘₐₓ and the associated maximum negative deviation V₁ₘᵢₙ, that is, (V₂ₘₐₓ−V₁ₘᵢₙ) is the maximum tolerated mutual voltage deviation of redundant analog signals that are to be compared to one another.

If one of the voltage values at the two signals B290 or B390 (V_{high} or V_{low}) is positive, then there is a greater deviation of the analog signals than should be tolerated. In the case that the processors that supply these analog signals are synchronized, then an error exists which must be stored and, if indicated, results in the output signals being switched off.

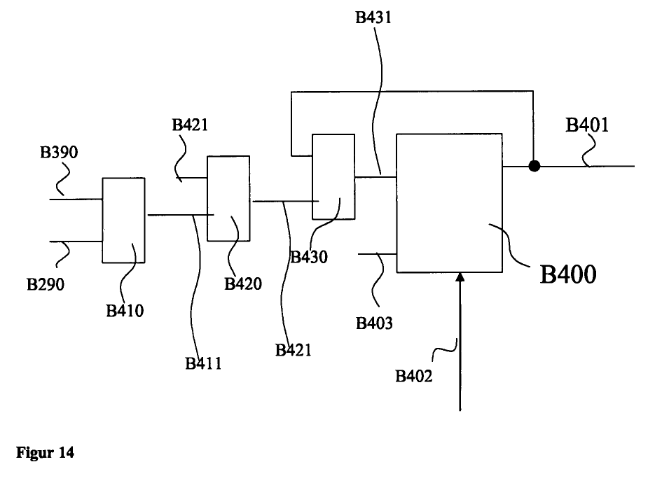

Synchronous operation is given when, for example, the ready signal in the control register of the processing units in question is active, or when specific digital signals that signal a certain state of the analog signal in question and thus also the value to be compared in the sense of an identifier, are sent to the SCU. A circuit that stores the error is shown in FIG. 14. In this circuit, the two input signals B390 and B290 are linked via a NOR circuit (logical OR circuit having subsequent inversion) B410 so as to form output signal B411. In an additional NOR element B420, this signal B411 is linked to input signal B421 so as to form output signal B421. This signal B421 is linked in an OR circuit B430 with signal B401 to form signal B431, which is used as an input signal for memory element (D flip-flop) B400. By value 1, output signal B401 of this element B400 indicates an error. D-flip-flop B400 stores a 1, using clock pulse B403, if one of the two voltage values V_{low} or V_{high} is present at signals B390 or B290 in positive form, that is, as a digital signal, has the value high; signal B421 is not active, and no reset signal B402 is present. The error remains stored until the signal reset has been active at least once. In the dimensioning of the circuits of FIGS. 11 through 13 it must be ensured that the resistors match one another, that is, the resistor ratios of R_{f} and Rᵢₙ, R₁ and R₂ as well as R₃ and R₄ are constant to the greatest extent, irrespective of manufacturing tolerances. Using signal B421, it is possible to control whether the circuit should be active, or whether the processing units are currently being synchronized, during which process no comparison should be made. Signal B402 resets a previous error and therefore permits a new comparison.

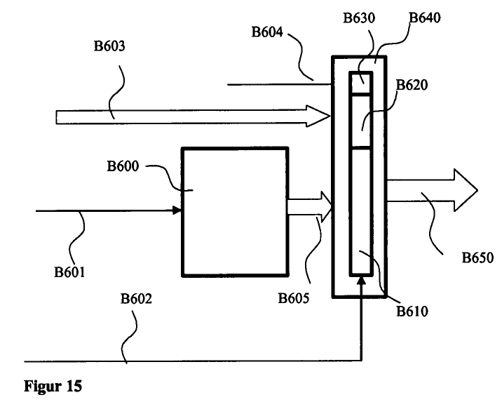

FIG. 15 shows an ADC. Depending on the existing requirements, for example with regard to conversion speed, accuracy, resolution, interference immunity, linearity and frequency spectrum, this ADC may be implemented using various conventional conversion methods. Thus, for example, the principle of successive approximation may be selected, where the analog signal is compared to a generated signal from a digital-to-analog converter (DAC) using a comparator, the digital input bits of the DAC being systematically set to high on a trial basis from the MSB (most significant bit) to the LSB (least significant bit), and being reset again precisely when the analog output signal of the DAC has a higher value than the analog input signal (the signal to be converted). Using its digital bits from LSB to MSB, the DAC controls either resistors or capacitances by applying weightings 1, 2, 4, 8, 16, . . . such that setting the next highest bit always has twice as great an effect on the analog value as the previous one. Once all bits have been set and possibly reset again on a trial basis, the value of the digital word corresponds to the digital representation of the analog input signal. For higher speed requirements, in the case of continuous data streams, a converter may also be used, which continuously processes the analog signal and outputs a serial digital signal, which approaches this analog data stream by the serial bit sequence. In this case, the digital word is represented by the bit sequence stored in a shift register. However, such converters are used on the assumption that continuous changes in the analog signal occur during the conversion period, because they are not able to process constant values. For lower speed requirements, converters according to a counting principle may be used as well, which, for instance, cause a corresponding constant charging or discharging of a capacitor combined to form an integrator, with the aid of the input voltage or the input current. The time required for this is measured and put into relation with the time necessary in the opposite direction for discharging or charging the same capacitor (integrator) using a reference voltage source or a corresponding reference current. The time unit is measured in clock pulses, and the number of clock pulses required is a measure of the analog input value. Such a method is, for instance, the dual slope method where the one slope is determined by the discharge corresponding to the analog value, and the second slope is determined by the recharging corresponding to the reference value (see also http://www.exstrom.com/journal/adc/dsadc.html).

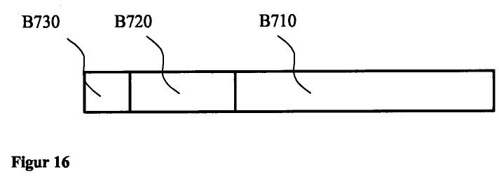

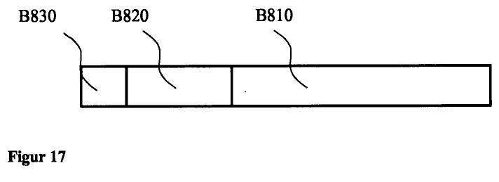

ADC B600 in FIG. 15 is controlled by a trigger signal B602, which usually is an output signal of the processor supplying the analog signal, and optionally an identifier B603 which provides information on the type of the analog signal that is being provided just then, in order to allow a distinction to be made between a plurality of analog signals. Using trigger signal B602, the converted analog word is copied into memory area B640 as digital value, into a register B610, and optionally together with identifier B603, which is stored in B620, and perhaps an additional signal B604 (that is 1 for the identification of an analog value), which is stored in memory B630. Memory area B640 may also be implemented as FIFO (first in, first out) if a plurality of values is to be stored, and the value stored first is also to be emitted again first. If memory area B640 is used both for digital as well as for digitized analog values, then all digital values may be supplemented by one bit A=0 at the MSB location, correspondingly to B630, in order to distinguish them from digitized analog values where A=1 (B630) (see FIGS. 16 and 17). Both B602 and B603 are components of digital output data Oᵢ of a processor i. In FIG. 16, the parts of the stored digitized analog value are shown separately, as they are being stored in the memory area. In this context, B710 is the digitized analog value itself, B720 is the associated identifier, and B730 is the analog bit that in this case is to be stored as 1. FIG. 17 shows a variant of a digital value stored in the same memory area. In B810, the digital value itself is stored, in B820 an identifier is stored optionally for this purpose, which, for instance, provides information on whether the digital word is to be compared at all, or which may also include other conditions for the comparison. Value 0 is then stored in B830 in order to indicate that it concerns a digital value.

To compare the buffer-stored digital and analog signals, the storing sequence and, in some instances, the A bit (B730 or B830) , as well as identifier B720 or B820 are checked in connection with converted digital value B710 or digital value B810. It is likewise possible to accommodate the analog and the digital signals in separate memories (two FIFOs), for example, due to the difference in bit width. The comparison then takes place in an event-controlled manner; whenever a value of a processor is transmitted to the SCU, it is checked whether the other participating processors have already provided such a value. If this is not the case, the value is stored in the corresponding FIFO or memory; otherwise, the comparison operation is carried out directly, it being possible for the FIFO to be used as a memory here as well. A comparison operation is always carried out, for example, when the participating FIFOs are not empty. In the case of more than two participating processors or compare signals, voting may be used to ascertain whether all signals are admitted for distribution (fail silent behavior) or whether perhaps only the error state is signaled by an error signal.

1-14. (canceled)

15. A method for switchover and for signal comparison for a computer system having at least two processing units, a switchover device being provided and a switch taking place between at least two operating modes, and a comparison device being provided; and a first operating mode corresponds to a compare mode, and a second operating mode corresponds to a performance mode, comprising:
comparing at least two analog signals of the processing units by converting at least one analog signal into at least one digital value.

16. The method according to claim 15, wherein at least two of the analog signals are asynchronous.

17. The method according to claim 15, wherein the digital signal is buffer-stored for a specifiable time so that a direct comparison is performable.

18. The method according to claim 15, wherein the conversion of at least one signal is implemented in at least one processing unit.

19. The method according to claim 15, wherein at least one analog signal is digitally converted, stored for a specifiable time, and reconverted into an analog signal for the comparison.

20. The method according to claim 15, wherein both analog signals are digitally converted in order to then be digitally available for comparison at the same time, by buffer-storing at least the converted digital value.

21. The method according to claim 15, wherein the digital value of each signal includes a plurality of bits, and a correspondingly specifiable number of bits is compared to each other as a function of a specifiable accuracy.

22. The method according to claim 15, wherein the analog signals and their digital values are compared to each other in redundant fashion.

23. The method according to claim 15, wherein an identifier is assigned to the analog signal in the conversion into a digital value.

24. The method according to claim 23, wherein the identifiers of two signals to be compared are assignable, and at least one of (a) only such signals and (b) their digital values are compared whose identifiers are assignable.

25. A device for a switchover and for signal comparison in a computer system having at least two processing units, comprising:
a switchover device configured to perform a switch between at least two operating modes, a first operating mode corresponding to a compare mode, a second operating mode corresponding to a performance mode;
a comparison device configured to compare at least two analog signals of the processing units; and
an analog-digital converter configured to convert at least one of the analog signals into at least one digital value.

26. The method according to claim 25, wherein at least two of the analog signals are asynchronous.

27. The method according to claim 25, wherein the digital signal is buffer-stored for a specifiable time so that a direct comparison is performable.

28. The method according to claim 25, wherein at least one processing unit is configured to convert the at least one analog signal.

29. A method for switchover and for signal comparison of a computer system having at least two processing units, comprising:
switching between at least two operating modes by a switchover device, a first operating mode corresponding to a compare mode, a second operating mode corresponding to a performance mode; and
comparing at least two analog signals of the processing units by a comparison device by converting at least one analog signal into at least one digital value.
